(19) United States
(12) Patent Application Publication
(10) Pub. No.: US 2024/0054265 A1
(43) Pub. Date: Feb. 15, 2024

(54) PARALLEL INVERSION METHOD AND SYSTEM FOR GROUND-BASED TRANSIENT ELECTROMAGNETIC METHOD

(71) Applicant: China University of Geosciences, Wuhan, Hubei (CN)

(72) Inventors: Hongzhu Cai, Hubei (CN); Minghong Liu, Hubei (CN); Xiangyun Hu, Hubei (CN)

(73) Assignee: China University of Geosciences, Wuhan, Hubei (CN)

(21) Appl. No.: 18/088,630

(22) Filed: Dec. 26, 2022

(30) Foreign Application Priority Data
Jul. 27, 2022 (CN) 202210888762.4

(51) Int. Cl. G06F 30/23

(52) U.S. Cl. CPC G06F 30/23

(57) ABSTRACT

The disclosure provides a parallel inversion method and system for a ground-based transient electromagnetic (TEM) method. The method includes acquiring observed TEM response data; dividing an inversion domain into unstructured tetrahedral grids and set a conductivity value, and constructing an initial inversion model and a regularized objective function; calculating the product of the sensitivity matrix and vector of the model parameters; converting the objective function into a least-squares problem by using the Gauss-Newton method, obtaining the model update direction, and using line search to obtain the optimal model update step length to update the inversion model; performing 3D TEM forward modeling based on the vector finite element method, and obtaining the predicted TEM response data; using the normalized error to evaluate the fit between the predicted TEM response data and the observed TEM response data; if the normalized fit difference reaches a preset threshold, the inversion method is terminated.

### CROSS-REFERENCE TO RELATED APPLICATION

This application claims the priority benefit of China application serial no. 202210888762.4, filed on Jul. 27, 2022. The entirety of the above-mentioned patent application is hereby incorporated by reference herein and made a part of this specification.

### BACKGROUND

### Technical Field

The disclosure belongs to the technical field of geophysical methods, and more particularly, relates to a parallel inversion method and system for ground-based transient electromagnetic (TEM) method.

### Description of Related Art

Electrical conductivity/resistivity is one of the physical properties inside the earth.

Obtaining the distribution information of subsurface resistivity can provide crucial support for solving geoscience and engineering problems. TEM, as the main branch of geophysical electromagnetic methods, is an important approach to obtain the subsurface resistivity distribution. TEM has the advantages of wide frequency band, strong anti-interference ability and flexible detection device, and has been commonly adopted in the fields of mineral, environmental engineering, and geological disaster monitoring. Therefore, accurate and reliable inversion of subsurface resistivity from TEM data is considered extremely important.

At present, apparent resistivity imaging and one-dimensional inversion method are widely adopted for TEM data interpretation. The former method may be used for qualitative interpretation, but the definition of apparent resistivity is vague and imprecise, and this method is only suitable for some areas with simple geological conditions. When the underground structure can be approximated by a layered model, the one-dimensional method can be applied to recover the layered conductivity. This method is commonly adopted in TEM data interpretation, but the pseudo-2D profile constructed from 1D inversion results often have abrupt changes in resistivity that make geological interpretation becomes challenging. By introducing lateral constraints and spatial constraints into one-dimensional inversion, the spatial continuity of one-dimensional inversion results can be enhanced to a certain extent. However, in complex geological conditions, the apparent resistivity imaging method and one-dimensional inversion cannot recover accurate subsurface structures.

Three-dimensional inversion is an effective method for accurate interpretation of TEM data. Forward modeling is the basis of inversion, the integral equation method and finite difference method are commonly applied to electromagnetic 3D forward modeling. Different methods have different advantages and disadvantages. The finite difference method is simple in principle and easy to implement, but it is difficult for this method to make accurate discretization of complex geometric structures, which is an insurmountable shortcoming. The modeling accuracy of the integral equation method depends largely on the condition of the coefficient matrix and the solution of the dyadic Green's function. The finite difference method uses the regular mesh to discretize the subsurface and it is challenging to approximate complex geological structures using this method. The finite element method is able to simulate complex terrain, geological bodies, and excitation electromagnetic sources of any shape by using flexible unstructured grid, and this method has very high calculation accuracy and is most suitable for fine detection, but the calculation efficiency still needs to be improved.

There are also a few study reports on the integral equation method, finite difference method, finite volume method and TEM 3D inversion based on regular grids. However, when the regular grid is adopted to discretize the model, it is difficult to take into account the influence of complex geological structures (such as terrain). In the meantime, the computational requirements for the TEM 3D inversion method are high, which limits the practical application of 3D inversion of TEM data to a large extent.

In brief, in order to achieve accurate interpretation of TEM data, it is necessary to solve the topography influence and computational efficiency of 3D TEM forward modeling and inversion, so as to make fine TEM detection possible.

### SUMMARY

In view of the defects of the related art, the purpose of the present disclosure is to provide a parallel inversion method and system for ground-based transient electromagnetic (TEM) method, aiming to solve the problem that there is a lack of consideration on terrain influence and calculation efficiency in the existing TEM three-dimensional forward and inversion modeling.

In order to achieve the above purpose, on the one hand, the present disclosure provides a parallel inversion method for ground TEM method, including the following steps:
S1: Acquiring observed TEM response data for inversion, including collecting the practical TEM data on the ground and using a theoretical model to obtain synthetic TEM response through three-dimensional TEM forward modeling; the theoretical model is a simulation model capable of obtaining theoretically observed TEM response;
S2: Dividing the inversion domain with unstructured tetrahedral grids; the inversion domain is an underground space corresponding to a measurement point and its nearby preset extension range;
S3: Setting conductivity values for the unstructured tetrahedral grids, constructing an initial model for the inversion, and combining the observed TEM data to construct the objective function for the inversion;
S4: Taking the derivative of the objective function with respect to the inversion parameters for the initial iteration, and adopting an implicit method of backward time stepping to calculate the sensitivity of the electric field along the element edges with respect to the model parameters, and then using the interpolation matrix to calculate the product of the sensitivity matrix and a vector;
S5: Considering the sensitivity matrix for the observed data and its multiplication with a vector, using the Gauss-Newton method with pseudo-quadratic convergence rate to convert the minimization problem of the objective function to a least-squares problem, obtaining the model update direction, and using line search method to obtain the optimized step length for model update;
S6: Calculating the model update based on the model update direction and the step length, and updating the inversion model;
S7: Performing 3D TEM forward modeling for the updated model using the edge-based finite element method, and obtaining the predicted TEM response;
S8: Using the normalized error to evaluate the data fitting between the observed data and the predicted data; terminate the inversion process if the normalized error is below the predefined threshold; if the normalized error does not reach the preset threshold, and the iteration number is less than the maximum iteration number, go to S4

More preferably, the method for obtaining theoretically observed TEM response data includes the following steps:

Applying the curl operator to the quasi-static time-domain Maxwell's equation, and obtaining the finite-element equations using the first order edge-based finite element method with unstructured tetrahedral discretization; using the element edges to simulate the TEM emission source by enforcing the wire or loops coincident with the element edges;

Discretizing the time derivatives in the finite element analysis equation by the second-order backward Euler method, and obtaining the time derivative of the electric field with non-uniform step size at each time moment using the Taylor series expansion, and re-arranging the equations for finite element analysis;

Using Dirichlet boundary conditions by assuming that the electric field vanishes on the boundary of the modeling domain, setting the zero initial condition for the electric field, and expanding the modeling domain, and refining the grid in the preset region of the measurement point and the emission source, and gradually increasing the size of the grid in other regions, completing the setting of boundary conditions and initial conditions, as well as the setting of the grid;

Based on the setting of boundary conditions and initial conditions and the setting of grid, using the direct solver to solve the finite element equation, and calculating the electric field at all time moments;

Calculating the theoretically observed TEM response data based on the electric field and a sparse interpolation matrix.

More preferably, the regularized objective function is:

$$φ ( m ) = {φ}_{d} ( m ) + {λφ}_{m} ( m )$$

$${φ}_{d} ( m ) = 0.5 {‖ {W}_{d} ( F ( m ) - {d}_{o b s} ) ‖}_{L 2}^{2}$$

$${φ}_{m} ( m ) = 0.5 {‖ {W}_{m} ( m - {m}_{r e f} ) ‖}_{L 2}^{2}$$

$$λ = \frac{{‖ {J}^{T} {W}_{d}^{T} {W}_{d} ( Jx ) ‖}_{L 2}}{{‖ {W}_{m}^{T} ( {W}_{m} x ) ‖}_{L 2}}$$

In the equation, φ_{d} is a data fitting term; φₘ is a model stabilizer term; λ is a regularization parameter; m is the model parameter; m=log(σ); σ is the conductivity; W_{d}=diag (1/(d_{obs}+ε); F(m) represents a forward response of the model parameter m, d_{obs} is the observed TEM response at the measurement point, Wm is a model roughness matrix, m_{ref} is a reference model with a prior information; x is a random vector; J is the sensitivity of the observed TEM response with respect to the model parameters; L2 is a 2-norm; ε is a smaller preset value.

More preferably, Sₙ=∂En/∂m.

In the equation, Sₙ is the sensitivity of the electric field along all element edges with respect to the model parameters at the n-th time step; the size of Sₙ is N_{ed}×Nₘ, where N_{ed} is the number of element edges; Nₘ is the number of model parameters;

Jₙ=QSₙ

In the equation, Q is a sparse interpolation matrix with size N_{d}×N_{ed}; Jₙ is the sensitivity of the observed TEM response at the n-th time step with respect to the model parameters; Na is the number of data; the number of data is the product of the number of time channels corresponding to the instrument used to measure the measurement point data and the number of measurement points.

More preferably, mₖ=mₖ₋₁+δmₖ.

In the equation, mₖ is the model parameter of the k-th inversion model; mₖ₋₁ is the model parameter of the k-1-th inversion model; δmₖ is the model update direction; l is the optimal model update step length.

On the other hand, the present disclosure provides a parallel inversion system for the ground-based TEM method, characteristic of that the system includes:
An acquisition module of TEM data is configured to obtain the observed TEM response data for inversion, including field data and a forward modeling unit to obtain synthetic TEM response for theoretical model;
A domain discretization module is configured to divide the inversion domain into unstructured tetrahedral grids; the inversion domain is the preset underground space under the measurement point with certain extension;
A constructing module of the initial inversion model is configured to set the conductivity value in the unstructured tetrahedral grid, construct the initial inversion model, and combine the observed TEM response data to construct the objective function of the initial model;
A sensitivity calculating module is configured to calculate the sensitivity of the observed TEM response to the model parameters, and take the derivative to the initial model in the finite element equation for the electric field. The implicit method of backward time stepping is adopted to gradually calculate the sensitivity transpose of the electric field along all element edges relative to the model parameters, then combine the sparse interpolation matrix to calculate the product of the sensitivity matrix and a vector;
An acquisition module of the model update parameters is configured to combine the sensitivity of the observed TEM response data to the model parameters, use the Gauss-Newton method with a quasi-quadratic convergence rate to convert the minimization of objective function into a least squares problem, obtain the model update direction, and use line search method to obtain the optimal model update step length;
A model update module is configured to calculate the model parameters by combining the model update direction and the optimal model update step length, and update the inversion model;
An acquisition module of predicted TEM response data is configured to perform 3D TEM forward modeling of the inversion model based on the vector finite element method, and obtain the predicted TEM data;
An error evaluation module is configured to evaluate the fitting between the predicted TEM response data and the observed TEM response data by using the normalized error; if the normalized error reaches the preset threshold, the inversion process is terminated; if the normalized error does not reach the preset threshold, and the number of current iteration is less than the preset maximum iteration, then drive the sensitivity calculation module of the observed TEM response data to the model parameters to perform operation.

More preferably, the theoretical model 3D TEM forward modeling unit includes:
A finite element solver is configured to take the curl operation on both sides of the quasi-static Maxwell equation in the time domain, and use the first-order vector finite element method based on the unstructured tetrahedral grid to obtain the equation for finite element analysis; the edge of the grid unit is adopted to discretize the TEM emission source, so that the wire or coil is coincident with the element edge;
A finite element analysis equation deformer is configured to discretize the time in the finite element analysis equation by using the second-order backward Euler method, and obtain the time derivative of the electric field using the non-uniform step size at various moments through the Taylor series expansion, and deform the finite element analysis equation;
A condition setter is configured to use Dirichlet boundary conditions by assuming that the electric field vanishes on the boundary of the modeling region, set the initial condition of the electric field to zero, and expand the modeling region of the theoretical model, and refine the grid in the preset region of the measurement point and the emission source, and gradually increase the size of the grid in other regions, complete the setting of boundary conditions and initial conditions, as well as the setting of the grid;
An electric field calculator is configured to solve the finite element analysis equation after deformation with a direct solver based on the setting of boundary conditions and initial conditions and the setting of grid, and calculate the electric field at various moments;
A calculator of observed TEM response data is configured to calculate observed TEM response data according to electric field and a sparse interpolation matrix.

More preferably, the regularized objective function is:

$$φ ( m ) = {φ}_{d} ( m ) + {λφ}_{m} ( m )$$

$${φ}_{d} ( m ) = 0.5 {‖ {W}_{d} ( F ( m ) - {d}_{o b s} ) ‖}_{L 2}^{2}$$

$${φ}_{m} ( m ) = 0.5 {‖ {W}_{m} ( m - {m}_{ref} ) ‖}_{L 2}^{2}$$

$$λ = \frac{{‖ {J}^{T} {W}_{d}^{T} {W}_{d} ( Jx ) ‖}_{L 2}}{{‖ {W}_{m}^{T} ( {W}_{m} x ) ‖}_{L 2}}$$

In the equation, φ_{d} is a data fitting term; φₘ is a model stabilizer term; λ is a regularization parameter; m is an inversion model parameter; m=log(σ); σ is a conductivity; W_{d}=diag (1/(d_{obs}+ε)); F(m) represents a forward response of the initial inversion model parameter m, d_{obs} is the observed TEM response data at the measurement point, Wₘ is a model roughness matrix, m_{ref} is a reference model parameter with prior information; x is random vector; J is the sensitivity of the observed TEM response data to the model parameters; L2 is a 2-norm; ε is a smaller preset value.

More preferably, the sensitivity of the electric field relative to the model parameters along all element edges is:

Sₙ=∂En/∂m;

In the equation, Sₙ is the sensitivity of the electric field along all element edges with respect to the model parameters at the n-th time step; the size of Sₙ is N_{ed}×Nₘ, where N_{ed} is the number of element edges; Nₘ is the number of model parameters;

Jₙ=QSₙ;

In the equation, Q is a sparse interpolation matrix with size N_{d}×N_{ed}; Jₙ is the sensitivity of the observed TEM data at the n-th time step to the model parameters; N_{d} is the number of data; the number of data is the product of the number of time channels corresponding to the instrument used to measure the measurement point data and the number of measurement points.

More preferably, the model parameters of the k-th inversion model are:

mₖ=mₖ₋₁+lδmₖ

In the equation, mₖ is the model parameter of the k-th inversion model; mₖ₋₁ is the model parameter of the k-1-th inversion model; δmₖ is the model update direction; l is the model update step length.

In general, compared with the related art, the above technical solutions conceived by the present disclosure have the following advantageous effects:

The disclosure provides a parallel inversion method for ground-based TEM method.

When acquiring the observed TEM response data, the curl on both sides of the quasi-static Maxwell equation system in the time domain is taken, and the first-order vector finite element method based on the unstructured tetrahedral grid is adopted to obtain the finite element analysis equation; Dirichlet boundary conditions are adopted to assume that the electric field vanishes on the boundary of the modeling region, and the initial condition of the electric field is set to zero, and the modeling region of the theoretical model is expanded. The grid is refined in the preset region of the measurement points and the emission sources, and the size of the grid is gradually increased in other regions, and the setting of boundary conditions and initial conditions as well as the setting of the grid are completed. In this manner, the TEM response of complex geological structures may be accurately simulated.

The disclosure adopts the adaptive time step technology in the forward modeling process, adopts the second-order backward Euler method to discretize the time in the finite element analysis, and adopts the adaptive time stepping method. After calculating the step size for a certain number of times with the time step Δtₙ₋₁, it is attempted to increase the step size to kₙ times Δtₙ₋₁. Moreover, through the Taylor series expansion, the time derivative of the electric field with non-uniform step size at various moments is obtained, and the finite element analysis equation is deformed. The present disclosure also takes into consideration that the iterative method is limited by the condition number of the equation, non-convergence may occur. After the boundary conditions and initial conditions are determined in the present disclosure, the electric field Eₙ at a certain moment may be obtained by solving the deformed finite element analysis equation by an iterative method or a direct method. During the solution process of the direct solver, when the time step is the same, and the stiffness matrix remains unchanged, the results of the matrix decomposition of finite element coefficient matrix Aₙ can be reused. Since the matrix decomposition of Aₙ for each Δtₙ has been stored, it is only necessary to perform the solution phase of the direct solver with backward substitution. During the inversion process, when the present disclosure uses the implicit method of backward time stepping to solve the matrix-vector multiplication between the sensitivity matrix and the vector, the matrix decomposition result of Aₙ is reused in the inversion process, and MPI and OpenMP are combined for parallel computing. To sum up, the present disclosure considerably improves the efficiency of the forward and inversion modeling methods.

Combined with the sensitivity of the observed TEM response data to the model parameters, the present disclosure uses the Gauss-Newton method with a quasi-quadratic convergence rate to convert the objective function into a least squares problem, has a quasi-quadratic convergence rate, obtains the model update direction, and uses line search to obtain the optimal model update step length, and therefore the method of the disclosure has good stability.

The disclosure calculates the product of the sensitivity matrix and the vector of the observed TEM response data to the model parameters by using the method provided with forward modeling, thus considerably reducing the large amount of calculation and memory requirements required for directly calculating the sensitivity matrix. Therefore, the inversion scheme formed by the present disclosure may efficiently solve the TEM three-dimensional inversion problem under complex geological conditions.

### BRIEF DESCRIPTION OF THE DRAWINGS

FIG. 1 is a flow chart of a parallel inversion method for ground-based TEM method provided by an embodiment of the present disclosure.

FIG. 2(a) is a uniform half-space model diagram corresponding to a global grid provided by an embodiment of the present disclosure, and the white box in the figure is a core region.

FIG. 2(b) is a uniform half-space model diagram corresponding to the core region provided by an embodiment of the present disclosure. The outline is the TEM emission source, the size is 300m×300m, the small white dots are the measurement points, and the observation point distance of 30m is adopted, and there are a total of 81 measurement points.

FIG. 3(a) is a sounding curve with coordinates (0, 0) obtained by using a uniform half-space model provided by an embodiment of the present disclosure.

FIG. 3(b) is a schematic diagram of the relative error of the 3D forward algorithm and the analytical solution corresponding to FIG. 3(a) according to an embodiment of the present disclosure.

FIG. 3(c) is a sounding curve with coordinates (−60m, −60m) obtained by using a uniform half-space model provided by an embodiment of the present disclosure.

FIG. 3(d) is a schematic diagram of the relative error of the 3D forward algorithm and the analytical solution corresponding to FIG. 3(c) according to an embodiment of the present

### DISCLOSURE

FIG. 4(a) is a ground TEM detection device provided by an embodiment of the present disclosure, in which a large fixed loop source device is adopted for observation, the emission loop frame does not move, and all parameters such as the emission current remain unchanged. The receiving part (receiving coil) move along the survey line in the emission frame, and the distance between the survey line and the survey point is 20 meters.

FIG. 4(b) is an emission waveform of a ground TEM detection device provided by an embodiment of the present disclosure, and the current turn-off time is 2.58×10⁴s.

FIG. 5 is a distribution of measurement points provided by an embodiment of the present disclosure. Each matrix represents the measurement points corresponding to different emission sources, and there are 16 emission sources in total.

FIG. 6(a) is a three-dimensional view obtained by adopting a theoretical model provided by an embodiment of the present disclosure.

FIG. 6(b) is a three-dimensional view obtained by using an initial inversion model provided by an embodiment of the present disclosure.

FIG. 6(c) is a three-dimensional view of a slice through the center of an abnormal body obtained by using the inversion result provided by an embodiment of the present disclosure, where Y=700m; the white dashed line represents the interface between two different layers in the inversion model, the white solid line is a contour of two abnormal bodies.

FIG. 7 is an inversion convergence curve provided by an embodiment of the present disclosure.

FIG. 8 is a normalized fitting difference distribution diagram of inversion result prediction data provided by an embodiment of the present disclosure.

FIG. 9(a) to FIG. 9(c) are schematic diagrams of data fitting of TEM sounding curves of randomly selected three measurement points according to an embodiment of the present disclosure.

### DESCRIPTION OF THE EMBODIMENTS

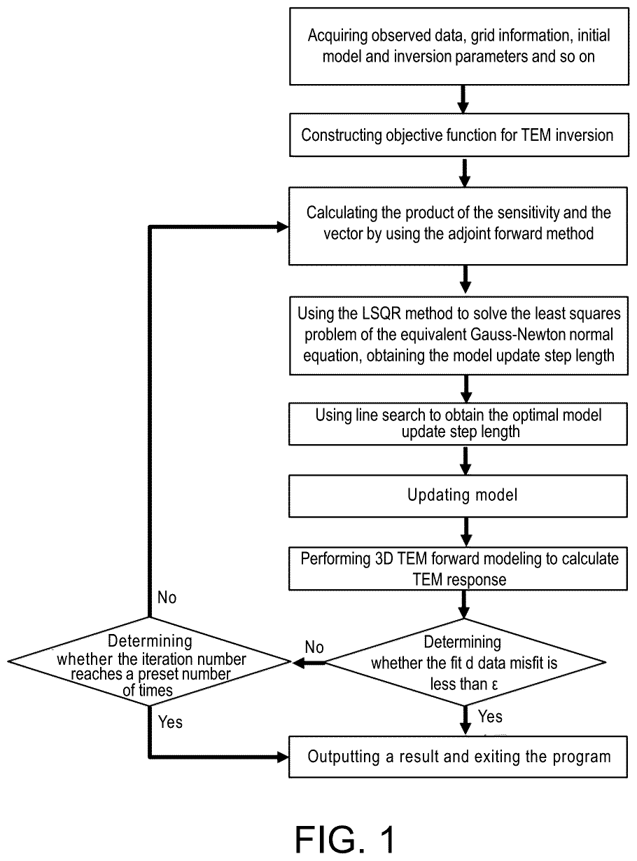

In order to make the purpose, technical solutions and advantages of the present disclosure clearer, the present disclosure will be further described in detail below with reference to the accompanying drawings and embodiments. It should be understood that the specific embodiments described herein are only used to explain the present disclosure, but not to limit the present disclosure. As shown in FIG. 1, on the one hand, the present disclosure provides a parallel inversion method for a ground-based transient electromagnetic (TEM) method, including the following steps:

S1: Acquiring observed TEM response data for inversion; collecting the observed TEM response data in actual measurement and using a theoretical model to obtain theoretically observed TEM response data through three-dimensional TEM forward modeling; it should be noted that the theoretical model herein refers to all existing simulation models capable of obtaining theoretically observed TEM data.

In the present disclosure, the TEM three-dimensional forward modeling adopts the vector finite element method of unstructured tetrahedral grid; and the method is specifically described as follows:

Starting from the quasi-static Maxwell equation in the time domain, by ignoring the displacement current term, it is possible to obtain the following:

∇×H=Jₑ+Jₛ; (1)

∇×E=−μ∂H/∂t; (2)

In the equation, H is a magnetic field strength; E is an electric field strength; p is a magnetic susceptibility; Jₑ is a conduction current density; and Jₛ is an external excitation field source current density.

In order to reduce the amount of calculation, by taking curl operator on both sides of Maxwell equation and eliminating the magnetic field term, the following diffusion equation may be obtained:

∇×∇×E+μσ∂Jₑ(t)/∂t=−ρ∂Jₛ(t)/∂t (3)

In the equation, σ is the conductivity.

In order to solve the equation (3), the present disclosure adopts the first-order vector finite element method based on the unstructured tetrahedral grid to obtain the finite element analysis equation:

KE(t)+μM_{σ}∂E(t)/∂t=−_{μ}M∂Jₛ(t)/∂t (4)

In the equation, K is a curl-curl operator, M_{σ} and M are stiffness matrices, respectively defined as:

K^{ij}=∫_{Ωe}(∇×Nᵢ)·(∇×Nᵢ)dv (5)

M^{ij}=∫_{Ωe}Nᵢ·Nⱼdv (6)

M_{σ}^{ij}=∫_{Ωe}Nᵢ·(\hat{σ}Nⱼ)dv (7)

In the equation, Nᵢ and Nⱼ are the basis functions of the domain Ωe of each computational unit; K^{ij} is the discrete form of the curl-curl operator; M^{ij} and M_{σ}^{ij} are the associated mass matrices; dv is the computational unit volume; Ωe is the computational unit domain. The inner product in equations (5) and (6) is calculated in analytical form, and equation (7) is calculated by using the Gaussian product of 11 sampling points. In equation (4), it is crucial to load the source term on the right (−μM∂Jₛ (t)/∂t). In the present disclosure, the edge of the grid unit is configured to discretize the TEM emission source, so that the wire or coil coincides with the edge of the grid unit, and the emission source is decomposed into a series of electrical dipole. The source term on the right side of equation (4) only contains the value on the edge of the TEM emission source, and its value is related to the edge length and waveform.

The disclosure adopts the second-order backward Euler method to discretize the time in the finite element analysis equation. In order to reduce the number of time steps required for simulation, the adaptive time stepping method is adopted. When the time step Δtₙ₋₁ is adopted to calculate a certain number of steps, it is attempted to increase the step size to kₙ times Δtₙ₋₁.

Δtₙ=kₙΔtₙ₋₁ (8)

Through the Taylor series expansion, the time derivative of the electric field with a non-uniform step size at time tₙ may be expressed as:

∂Eₙ/∂t≈((2kₙ+1)Eₙ₋(kₙ+1)²Eₙ₋₁+kₙ²Eₙ₋₂)/((kₙ+1)Δtₙ) (9)

By substituting equation (9) into equation (4), it is possible to obtain the following:

$$K {E}_{n} + \frac{( 2 {k}_{n} + 1 ) μ}{( {k}_{n} + 1 ) Δ {t}_{n}} {M}_{σ} {E}_{n} = \frac{μ \partial }{Δ {t}_{n}} M [ ( {k}_{n} + 1 ) {E}_{n - 1} - \frac{{k}_{n}^{2}}{( {k}_{1} + 1 )} {E}_{n - 2} ] - μ M \frac{\partial {J}_{s} ( t )}{\partial t} \qquad ( 10 )$$

Equation (10) may be organized into the following form:

AₙEₙ=bₙ (11)

In the equation, Aₙ finite element coefficient matrix is

$$K + \frac{( 2 {k}_{n} + 1 ) μ}{( {k}_{n} + 1 ) Δ {t}_{n}} {M}_{σ} ;$$

bₙ is

$$\frac{μ \partial }{Δ {t}_{n}} M [ ( {k}_{n} + 1 ) {E}_{n - 1} - \frac{{k}_{n}^{2}}{( {k}_{1} + 1 )} {E}_{n - 2} ] - μ M \frac{\partial {J}_{s} ( t )}{\partial t} .$$

Solving equation (11) requires appropriate boundary conditions to specify the electromagnetic field on the boundary of the modelling domain to obtain a unique solution. The present disclosure adopts the Dirichlet boundary condition to assume that the electric field vanishes on the boundary of the modeling domain of the theoretical model:

E(t)_{Ω}=0 (12)

In the equation, Ω is the modeling domain boundary.

The modelling region is expanded to a boundary of several kilometers to hundreds of kilometers to match the use of Dirichlet boundary conditions. The range of the boundary depends on the size of the emitter electrode distance, the maximum time of the simulation required, and the model medium distribution. However, the grids are refined near the measurement points and emission sources to accurately simulate terrain and complex three-dimensional geological bodies and ensure calculation accuracy. By gradually increasing the size of the grids outside the core region, it is possible to reduce the number of grids and improve efficiency. By comparing with the analytical solution for the homogeneous half-space, it possible to determine whether the boundary range is appropriate.

Solving equation (11) also requires suitable initial conditions. The present disclosure adopts the initial condition of zero electric field, and realizes the loading of the emission source by substituting the discrete emission current density Jₛ into equation (11), so that it is possible to simulate any emission waveforms.

After the boundary conditions and initial conditions are determined, the electric field Eₙ at a certain moment may be obtained by solving equation (11) through the iterative method or the direct method. Considering that the iterative method is strongly affected by the condition number of the system of equations, the situation of non-convergence might occur. In the present disclosure, a cluster parallel version of the Intel MKL PARDISO direct solver is adopted to solve equation (11). When the time step is the same, the stiffness matrix remains unchanged, and the results of the matrix decomposition of finite element matrix Aₙ may be reused. Since the matrix decomposition of Aₙ for each Δtₙ has been stored, it is only necessary to perform the back-substitution solution phase of the direct solver.

Furthermore, matrix-vector multiplication between the sensitivity matrix (or its transpose) and the vector involves forward and backward time stepping; direct solvers are still required to solve similar systems of equations in these processes.

Once the electric field is obtained by solving equation (11), the observed TEM data (∂H/∂t) at the measurement point may be obtained by the following interpolation matrix:

d_{obs}=QE (13)

In the equation, Q is a sparse interpolation matrix with size N_{d}×N_{ed}; Ndand N_{ed} represent the number of data and the number of grid edges; d_{obs} is ∂H/∂t; E is the electric field; the number of data is the product of the number of time channels corresponding to the instrument used to measure the data of the measurement points and the number of measurement points.

S2: Dividing the inversion domain by using unstructured tetrahedral grids; the inversion domain is an underground space corresponding to a measurement point and its nearby preset extension range.

The disclosure adopts the unstructured tetrahedral grid method to discretize the inversion domain, and by using the unstructured grid, the local refinement of key regions (such as the emission source and the measurement point) may be easily realized. The local refinement near the emission source makes the implementation of the full-field method easier, and the refinement around the measurement point makes it possible to obtain very accurate simulation results.

S3: Setting a conductivity value in the unstructured tetrahedral grid obtained in S2, constructing an initial inversion model.

In the 3D inversion, the selection of the initial inversion model will affect the inversion result and the convergence speed. If the selected initial inversion model is considerably different from the true model, the TEM inversion may not converge and could provide inaccurate inversion results. Therefore, constructing a suitable initial inversion model is of great significance to obtain high-quality inversion results. In general, a simple initial inversion model may be established with reference to the existing drilling, geological and geophysical a prior information. However, when there is a lack of a prior information of a region where the geological conditions are complex, one-dimensional inversion may be performed first, and the one-dimensional inversion result may be used as the initial model.

S4: Constructing objective function for TEM inversion.

The three-dimensional inversion of TEM data is an ill-posed problem, and the regularized objective function may be used to obtain a solution with geophysical significance; the regularized objective function is:

φ(m)=φd(m)+λφm(m) (14)

In the equation, φ_{d} is the data fitting term; φₘ is the model stabilizer term; λ is the regularization parameter; φ_{d}, φₘ and λ are used to balance data fitting and model constraints.

φ_{d} and φₘ are respectively defined as:

φ_{d}(m)=0.5∥W_{d}(F(m)−d_{obs})∥²L2 (15)

φₘ(m)=0.5∥Wₘ(m−m_{ref})∥²L2 (16)

In the equation, m is the inversion model parameter. In order to ensure that m is a non-negative number during the inversion process so that the model parameters have physical meaning, the conductivity in the logarithmic domain is taken as the model parameter, m=log(σ), and W_{d} is the data weighting matrix. Since the TEM data spans multiple orders of magnitude, in order to balance the data weights of different time channels, the model is constructed by using the derivative of the observed TEM response data on the measurement point, where W_{d}=diag (1/(d_{obs}+ε)). Since the TEM data may contain “change sign”, a smaller value ε is added to the denominator to avoid the infinite value in the data weight, and s may be taken from the average of the observed data of the last time channel. F(m) represents the forward response of the initial inversion model parameter m, d_{obs} is the observed TEM response data on the measurement point, Wₘ is the model roughness matrix, and m_{ref} is the reference model parameter with a prior information.

The regularization parameter plays an important role in weighing the data fitting term and the model constraint term. The selection of the regularization parameter affects the stability and convergence speed of the algorithm. Aₙ approximate spectral analysis method is adopted to calculate the regularization parameter:

$$λ = \frac{{‖ {J}^{T} {W}_{d}^{T} {W}_{d} ( Jx ) ‖}_{L 2}}{{‖ {W}_{m}^{T} ( {W}_{m} x ) ‖}_{L 2}} \qquad ( 17 )$$

In the equation, x is a random vector; in inversion, equation (17) is adopted to calculate the regularization parameter in the initial iteration; in subsequent iterations, when convergence is slow, the value of λ is reduced by using a cooling method, or the equation (17) is adopted again to calculate the regularization parameter.

The roughness matrix is constructed according to the weight of the volume and distance of the N inversion units closest to the inversion unit, which is expressed as follows:

Wₘ(i,j)=Vᵢ(\sqrt{Vᵢⱼ/Σₖ₌₁^{N}Vᵢₖ})rᵢⱼ (18)

In the equation, Vᵢ is the volume of the i-th inversion unit; Vᵢⱼ represents the volume of the j-th nearest inversion unit corresponding to the i-th inversion unit; Vᵢₖ represents the volume of the k-th nearest inversion unit corresponding to the i-th inversion unit; rᵢⱼ represents the distance from the center of the i-th inversion unit to the center of the j-th nearest unit, and is calculated by the following equation:

rᵢⱼ=(xᵢ−xⱼ)²+(yᵢ−yⱼ)²+(zᵢ−Zⱼ)² (19)

In the equation, (xᵢ, yᵢ, zᵢ) and (xⱼ, yⱼ, zⱼ) are the center coordinates of the center of the i-th inversion unit and the j-th inversion unit; in the above method, the smoothness of the inversion result may be controlled through the parameter N, but the larger N is, the smoother the inversion result is.

S5: Calculating the product of the sensitivity matrix (or the transpose of the sensitivity matrix) and the vector by using the adjoint forward method.

The sensitivity matrix represents the variation of the electric field along all element edges relative to the variation of the model, which may be obtained by taking the derivative with respect to the model parameter m in equations (10) and (11).

$${A}_{n} \frac{\partial {E}_{n}}{\partial m} - \frac{( 2 {k}_{n} + 1 ) μ}{Δ {t}_{n}} {M}_{σ} \frac{\partial {E}_{n - 1}}{\partial m} + \frac{{k}_{n}^{2} μ}{( {k}_{n} + 1 ) Δ {t}_{n}} {M}_{σ} \frac{\partial {E}_{n - 2}}{\partial m} = - \frac{μ}{Δ {t}_{n}} \frac{\partial {M}_{σ}}{\partial m} [ \frac{( 2 {k}_{n} + 1 )}{( {k}_{n} + 1 )} {E}_{n} - ( {k}_{n} + 1 ) {E}_{n - 1} + \frac{{k}_{n}^{2}}{( {k}_{n} + 1 )} {E}_{n - 2} ] \qquad ( 20 )$$

Defining the sensitivity of the electric field along all element edges with respect to the model parameters as S, where S, represents the sensitivity at the n-th time step.

Sₙ=∂En/∂m (21)

In the equation, the size of Sₙ is N_{ed}×Nₘ, N_{ed} is the number of edges; Nₘ is the number of model parameters.

For brevity, the following definitions are also provided:

$${B}_{n} = \frac{μ}{Δ {t}_{n}} {M}_{σ} \qquad ( 22 )$$

$${G}_{n} = - \frac{μ}{Δ {t}_{n}} \frac{\partial {M}_{σ}}{\partial m} [ \frac{( 2 {k}_{n} + 1 )}{( {k}_{n} + 1 )} {E}_{n} - ( {k}_{n} + 1 ) {E}_{n - 1} + \frac{{k}_{n}^{2}}{( {k}_{n} + 1 )} {E}_{n - 2} ] \qquad ( 23 )$$

By substituting equation (21), equation (22) and equation (23) into equation (20), it is possible to obtain:

$${A}_{n} {S}_{n} - ( {k}_{n} + 1 ) {B}_{n} {S}_{n - 1} + \frac{{k}_{n}^{2}}{( {k}_{n} + 1 )} {B}_{n} {S}_{n - 2} = {G}_{n} \qquad ( 24 )$$

In the equation: Sₙ₋₁ and Sₙ₋₂ represent the sensitivity of electric field at n-1-th and n-2-th time steps, respectively. The number of columns of the matrix Gₙ is subjected to the number of model parameters Nₘ, and Nₘ is normally very large (practical problems range from tens of thousands of to millions). Therefore, the computation for directly solving equation (24) is very expensive.

The sensitivity of the observed TEM response data to the model parameters is defined as J, Jₙ is the observed data sensitivity at the n-th time step, with a size of N_{d}×Nₘ, where N_{d} is the number of observed data, and Nₘ is the number of model parameters; the relationship between Sₙ and Jₙ is expressed by the following equation:

Jₙ=QSₙ (25)

The sensitivity of the data in all time channels may be written as all-in-one form.

$$J = diag ( \begin{matrix}Q \\ Q \\ … \\ Q \\ Q\end{matrix} ) {( \begin{matrix}{A}_{1} & & & & \\ - ( {k}_{2} + 1 ) {B}_{2} & {A}_{2} & & & \\ & & … & & \\ & \text{?} {B}_{n - 1} & - ( {k}_{n - 1} + 1 ) {B}_{n - 1} & {A}_{n - 1} & \\ & & \text{?} & - ( {k}_{n - 1} + 1 ) {B}_{n - 1} & {A}_{n}\end{matrix} )}^{- 1} ( \begin{matrix}{G}_{1} \\ {G}_{2} \\ … \\ {G}_{n - 1} \\ {G}_{n}\end{matrix} ) \qquad ( 26 )$$

$$\text{?} \text{indicates text missing or illegible when filed}$$

Typically, the number of data is much smaller than the number of model parameters; therefore, by taking the transpose of equation (26), it is possible to obtain the transpose of the sensitivity matrix.

$${J}^{T} = {( \begin{matrix}{G}_{1} \\ {G}_{2} \\ … \\ {G}_{n - 1} \\ {G}_{n}\end{matrix} )}^{T} {( \begin{matrix}{A}_{1} & - ( {k}_{2} + 1 ) {B}_{2} & \text{?} {B}_{3} & & \\ & {A}_{2} & - ( {k}_{3} + 1 ) {B}_{3} & & \\ & & … & & \\ & & & {A}_{n - 1} & - ( {k}_{n} + 1 ) {B}_{n} \\ & & & & {A}_{n}\end{matrix} )}^{- 1} diag ( \begin{matrix}{Q}^{T} \\ {Q}^{T} \\ … \\ {Q}^{T} \\ {Q}^{T}\end{matrix} ) \qquad ( 27 )$$

$$\text{?} \text{indicates text missing or illegible when filed}$$

In the equation, T represents transpose.

It is costly to perform matrix factorization of the whole of equation (27); therefore, a general solution is to solve the transpose of the sensitivity matrix step by step. Contrary to the way the forward problem solves the forward step of equation (11), the backward stepping method is adopted to solve the sensitivity; the right-hand term of equation (27) depends on the QT with fewer columns. However, the explicit computation of the sensitivity matrix or its transpose is still very difficult for practical TEM inversion problems. When the present disclosure uses the implicit method of backward time stepping to solve the sensitivity matrix, the matrix-vector multiplication between the calculation sensitivity matrix (or its transpose) and the vector is adopted. In forward modeling, the adaptive time stepping method only needs to update the matrix Aₙ several times, and its matrix decomposition is stored. During inversion, these matrix decomposition results will be reused during inversion when calculating matrix-vector multiplications between J (or J^{T}) and vectors. Each calculation of the product of the J matrix and the vector is equivalent to a forward calculation, and the parallel calculation using MPI and OpenMP may effectively speed up the inversion.

S6: Using the LSQR method to solve the least squares problem of the equivalent Gauss-Newton normal equation, obtaining the model update direction, obtaining the optimal model update step length by line search, and updating the prediction model.

The objective function is minimized by the Gauss-Newton method with a quasi-quadratic convergence rate, the Taylor expansion formula is applied to the objective function, and the higher-order terms are ignored to obtain the following normal equation:

[(W_{d}J)^{T}W_{d}J+λWₘ^{T}Wₘ]δmₖ=−J^{T}W_{d}^{T}W_{d}rₖ₋₁λWₘ^{T}Wₘ(mₖ₋₁−m_{ref}) (28)

In the equation, δmₖ is the model update direction, data error rₖ₋₁=F (mₖ₋₁)−d_{obs}, k is the number of iterations; and the normal equation is converted into the following least squares form:

$$[ \begin{matrix}{W}_{d} J \\ λ {W}_{m}\end{matrix} ] δ {m}_{k} = [ \begin{matrix}{W}_{d} {r}_{n - 1} \\ λ {W}_{m} ( {m}_{n - 1} - {m}_{ref} )\end{matrix} ] \qquad ( 29 )$$

The least squares (LSQR) algorithm is adopted to solve equation (29) to obtain the model update direction, and the line search method is adopted to find the optimized model update step length 1. The model update may be expressed as:

mₖ=mₖ₋₁+lδmₖ (30)

S7: Performing 3D TEM forward modeling on the prediction model mₖ based on the vector finite element method, and obtaining the TEM response data of the prediction model; the adaptive time step technology, Intel MKL Pardiso direct solver, MPI and OpenMP parallel computing technology are combined in the forward modeling to improve computing efficiency.

S8: Using the normalized error evaluation model to evaluate the fitting between the observed data and the predicted data, determining whether the data misfit reaches a preset threshold, and determining whether the iteration number reaches the preset maximum number of iterations.

To determine whether the observed TEM response data and the predicted TEM response data are well fitted, the normalized misfit between the observed TEM response data and the predicted TEM response dₚᵣₑ may be expressed by the following equation:

$$misfit = \frac{{‖ {w}_{d} ( {d}_{obs} - {d}_{pre} ) ‖}_{L 2}}{{‖ {w}_{d} {d}_{obs} ‖}_{L 2}} \qquad ( 31 )$$

When the data misfit reaches the set threshold or the convergence stops, the inversion algorithm is terminated and the inversion result is output. If the data misfit does not reach the set minimum data misfit, it is determined whether the number of current iteration reaches the maximum number of inversion iteration, if the number of current iteration is less than the set number of times, the next iteration will be performed in a loop; if the number of current iteration reaches the set number of times, the inversion iteration will be stopped and the inversion result will be output.

S9: Iteratively executing S5-S8 until the set termination condition is satisfied, thereby obtaining the conductivity model to realize the three-dimensional inversion of the TEM.

On the other hand, the present disclosure provides a parallel inversion system for ground-based TEM method, characterized in that the system includes:
Aₙ acquisition module of TEM data is configured to obtain the observed TEM response data for inversion, including a field data and a three-dimensional TEM forward modeling unit for the theoretical model, which respectively obtain the actual observed TEM response data and the theoretically observed TEM response data;
A space division module is configured to divide the inversion domain into unstructured tetrahedral grids; the inversion domain is the underground space corresponding to the measurement point and its nearby preset extension range;
A constructing module of the initial inversion model is configured to set the conductivity value in the unstructured tetrahedral grid, construct the initial inversion model, and combine the observed TEM response data to construct the objective function of the initial inversion model;
A sensitivity calculating module is configured to calculate the sensitivity of the observed TEM response data to the model parameters, and take the derivative of the electric field along the edges with respect to the model parameter for the initial iteration. The implicit method of backward time stepping is adopted to gradually calculate the sensitivity transpose of the electric field along all element edges relative to the model parameters, then combine the sparse interpolation matrix to calculate the product of the sensitivity matrix and the vector of the observed TEM response data to the model parameters;
Aₙ acquisition module of the model update parameters is configured to combine the sensitivity of the observed TEM response data to the model parameters, use the Gauss-Newton method with a quasi-quadratic convergence rate to convert the objective function into a least squares problem, obtain the model update direction, and use line search to obtain the optimal model update step length;
A model update module is configured to calculate the model parameters by combining the model update direction and the optimal model update step length, and update the inversion model;
Aₙ acquisition module of predicted TEM response data is configured to perform 3D TEM forward modeling of the inversion model based on the vector finite element method, and obtain the predicted TEM response data;
Aₙ error evaluation module is configured to evaluate the fit between the predicted TEM response data and the observed TEM response data by using the normalized error; if the normalized error reaches the preset threshold, the inversion method is terminated; if the normalized error does not reach the preset threshold, and the number of current iteration is less than a set number of times, then drive the sensitivity calculation module of the observed TEM response data to the model parameters to perform operation.

More preferably, the acquisition module of the TEM data includes a field data acquisition unit and an observed TEM response data acquisition unit.

The 3D TEM forward modeling unit for theoretical model includes:

A finite element equation is configured to take the curl on both sides of the quasi-static Maxwell equation in the time domain, and use the first-order vector finite element method based on the unstructured tetrahedral grid to obtain the finite element analysis equation; the element edge is used to discretize the TEM emission source, so that the wire or coil is coincident with the edge of the grid unit;

A finite element analysis equation deformer is configured to discretize the time in the finite element analysis equation by using the second-order backward Euler method, and obtain the derivative of electric field using the non-uniform step size at various moments through the Taylor series expansion, and deform the finite element analysis equation;

A condition setter is configured to use Dirichlet boundary conditions to assume that the electric field vanishes on the boundary of the modeling region, set the initial condition of the electric field to zero, and expand the modeling region of the theoretical model, and refine the grid in the preset region of the measurement point and the emission source, and gradually increase the size of the grid in other regions, complete the setting of boundary conditions and initial conditions, as well as the setting of the grid;

Aₙ electric field calculator is configured to solve the finite element analysis equation after deformation with a direct solver based on the setting of boundary conditions and initial conditions and the setting of grid, and calculate the electric field at various moments;

A calculator of observed TEM response data is configured to calculate observed TEM response data according to an electric field and a sparse interpolation matrix.

More preferably, the regularized objective function is:

$$φ ( m ) = {φ}_{d} ( m ) + {λφ}_{m} ( m )$$

$${φ}_{d} ( m ) = 0.5 {‖ {W}_{d} ( F ( m ) - {d}_{o b s} ) ‖}_{L 2}^{2}$$

$${φ}_{m} ( m ) = 0.5 {‖ {W}_{m} ( m - {m}_{ref} ) ‖}_{L 2}^{2}$$

$$λ = \frac{{‖ {J}^{T} {W}_{d}^{T} {W}_{d} ( Jx ) ‖}_{L 2}}{{‖ {W}_{m}^{T} ( {W}_{m} x ) ‖}_{L 2}}$$

In the equation, φ_{d} is a data fitting term; φₘ is a model stabilizer term; λ is a regularization parameter; m is an inversion model parameter; m=log(σ); σ is a conductivity; W_{d}=diag (1/(d_{obs}+ε)); F(m) represents a forward response of the initial inversion model parameter m, d_{obs} is the observed TEM response data at the measurement point, Wₘ is a model roughness matrix, m_{ref} is a reference model parameter with prior information; x is a random vector; J is the sensitivity matrix; L2 is a 2-norm; E is a smaller preset value.

More preferably, the sensitivity of the electric field relative to the model parameters along all element edges is:

Sₙ=∂En/∂m;
In the equation, Sₙ is the sensitivity of the electric field along all element edges relative to the model parameters at the n-th time step; the size of Sₙ is N_{ed}×Nₘ, where N_{ed} is the number of grid edges; Nₘ is the number of model parameters;

Jₙ=QSₙ;

In the equation, Q is a sparse interpolation matrix with size N_{d}×N_{ed}; J is the sensitivity of the observed TEM response data to the model parameters; Nd is the number of data; the number of data is the product of the number of time channels corresponding to the instrument used to measure the measurement point data and the number of measurement points.

More preferably, the model parameters of the k-th inversion model are:

mₖ=mₖ₋₁+lδmₖ

In the equation, mₖ is the model parameter of the k-th inversion model; mₖ₋₁ is the model parameter of the k-1-th inversion model; δmₖ is the model update direction; l is the optimal model update step length.

### Example 1

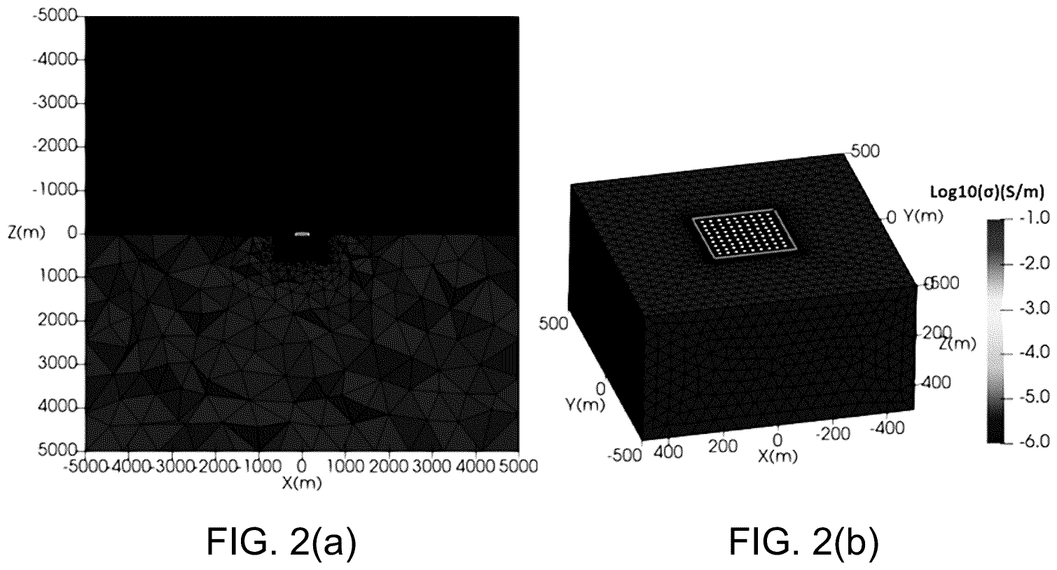

In order to verify the effectiveness of the TEM three-dimensional forward modeling provided by the present disclosure, the Example provides a uniform half-space model as shown in FIG. 2(a) and FIG. 2(b), in which the conductivity of the underground space is 0.1S/m, the conductivity of the air layer is 10⁻⁶S/m. The white frame in FIG. 2(b) is the emission frame and emission source, the size is 300×300m, the white points are measurement points, an observation point distance of 30m is adopted, and there are a total of 81 measurement points. The emission waveform is a sloping step-off wave, the current turn-off time is 5×10-6 s, observation times are taken at equally logarithmically intervals 10−4˜10−1.5 s, and there are a total of 25 time channels; the number of data is 81×25=2025.

In this example, the analytical solution is obtained by the analytical method, which is completed on a high-performance computing cluster. Each node contains 2 Inter(R) Xeon(R) 2.5 GHz CPUs, each CPU contains 20 cores, and the memory of a single node is 384 GB. One node is used for calculation. When the adaptive time stepping method is used for forward modeling, the slope step waveform is discretized into 10 segments, and the initial time step is 5×10−7 s. After calculating the equal step size Δtₙ every 20 times, it is attempted to change the time step size to 2 times the current step size. The calculation is completed after 241 steps, there are 12 different step lengths in total, and the calculation time is 154 s. When using uniform step length calculation, a total of 63246 steps need to be calculated, which takes about 4 hours and 50 minutes.

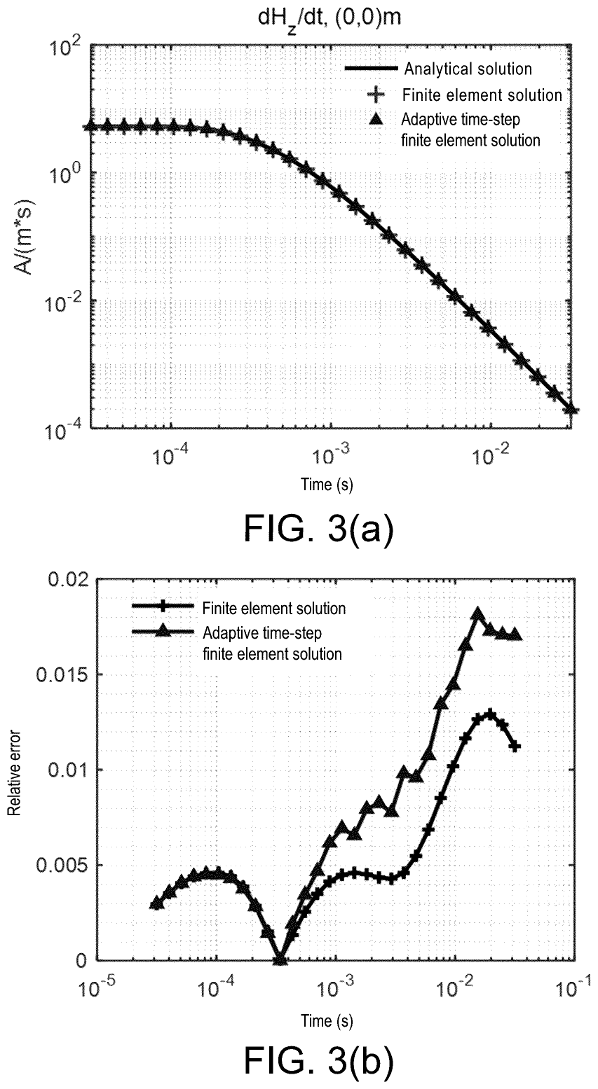

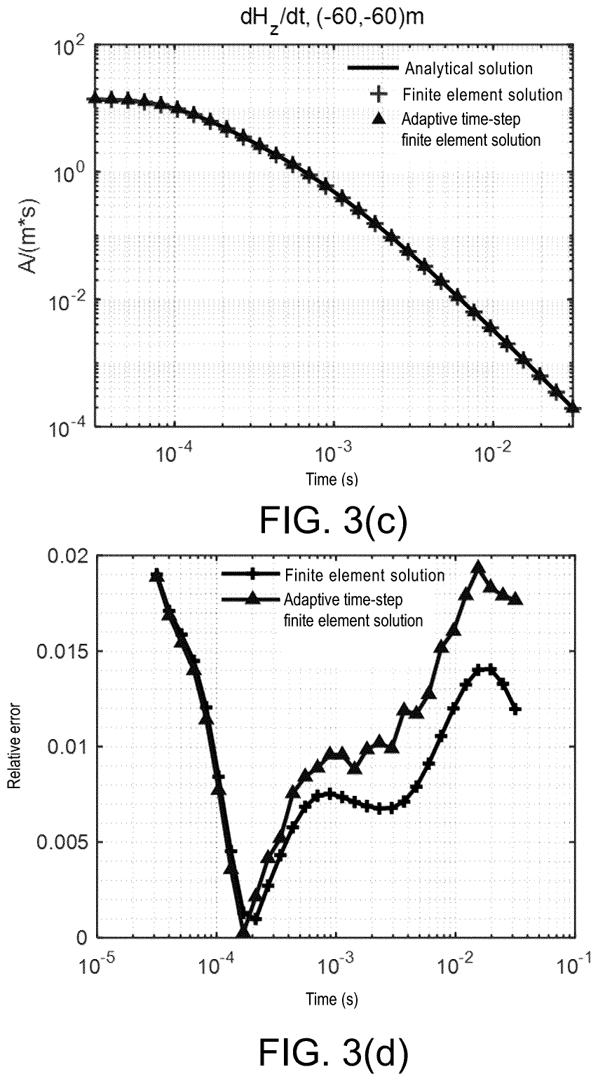

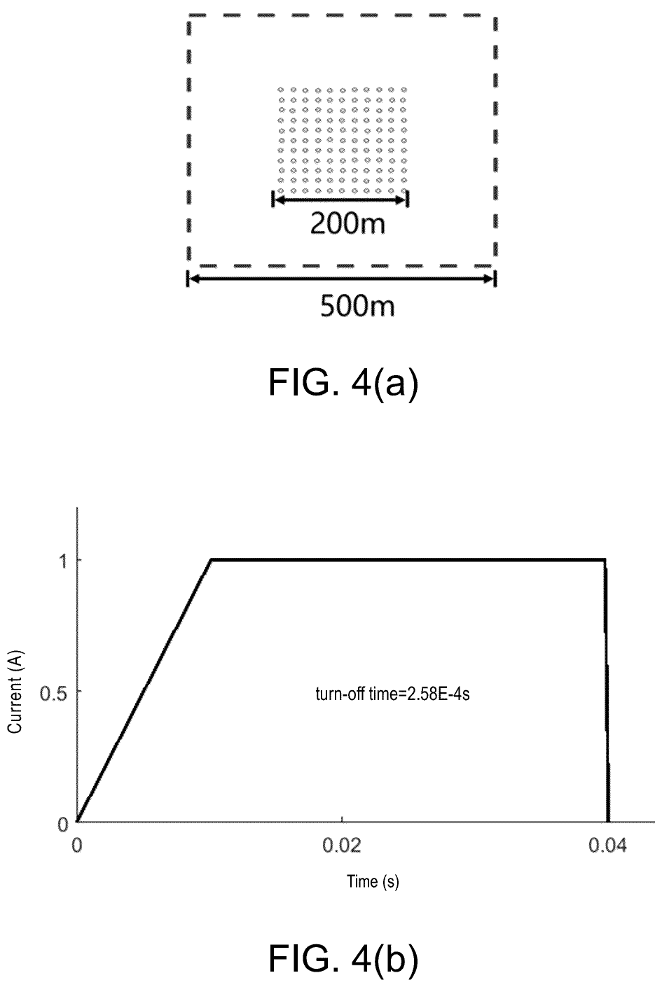

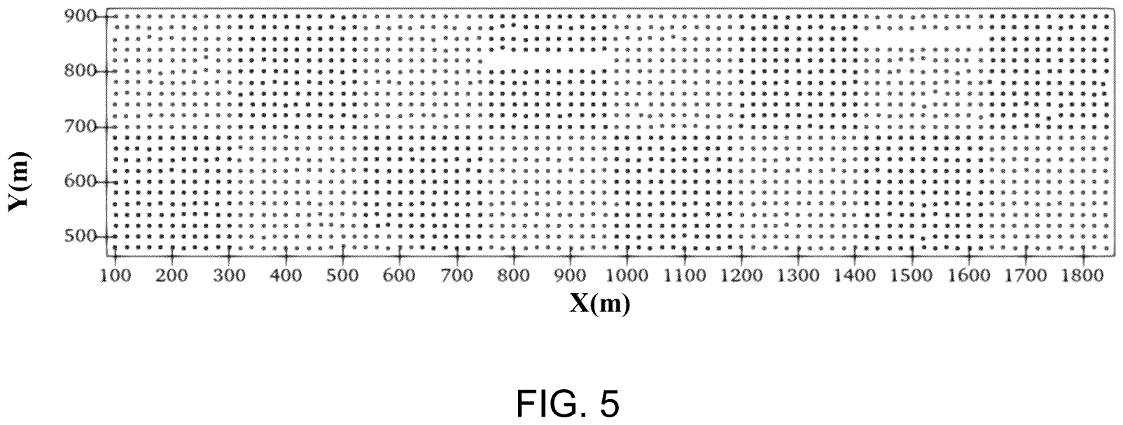

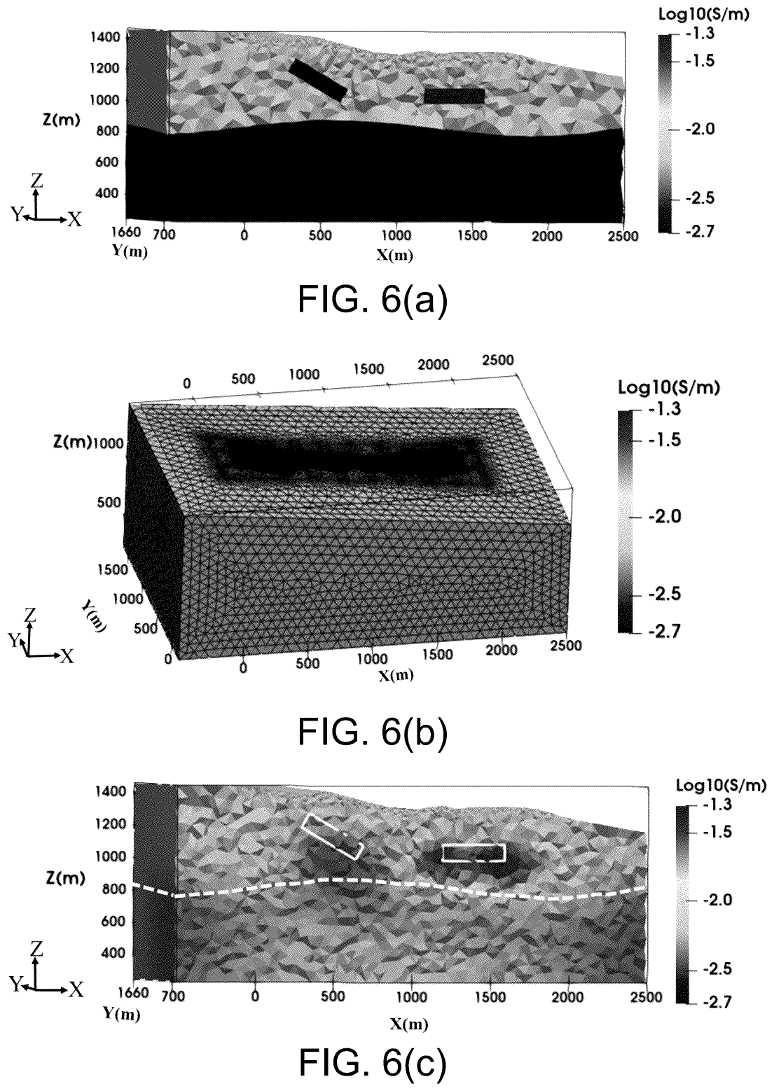

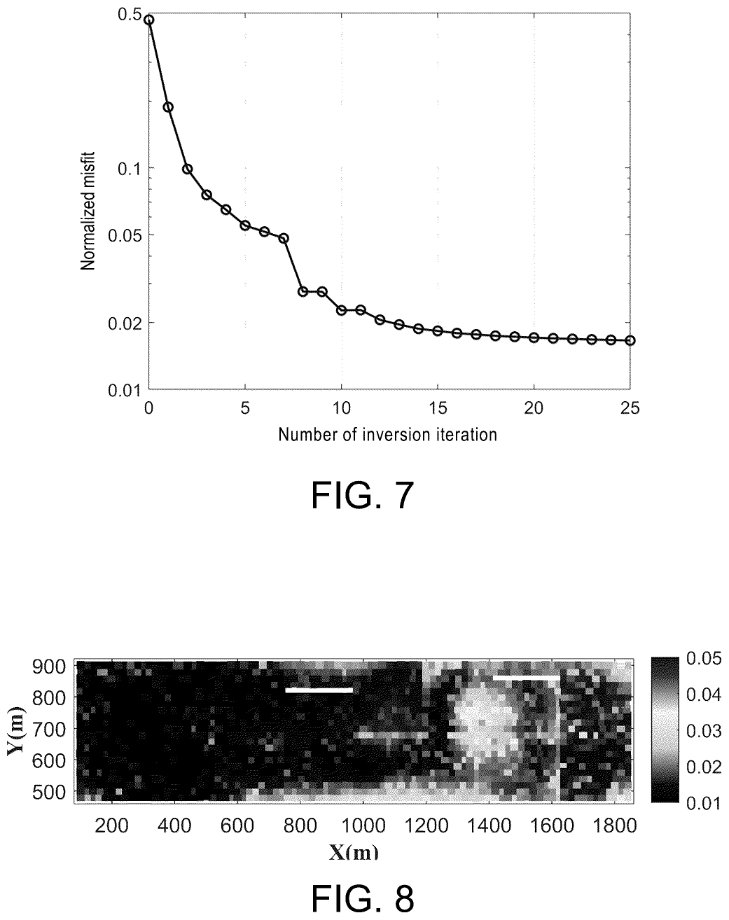

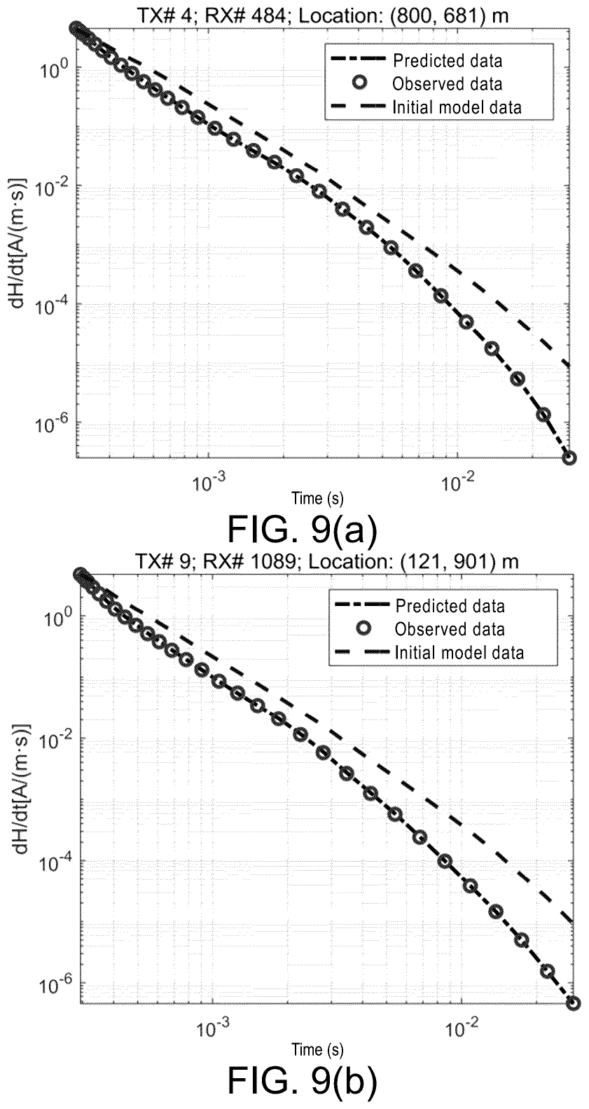

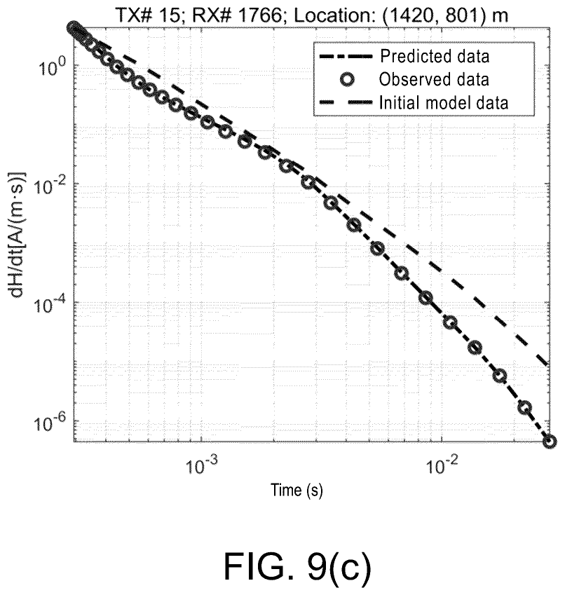

In comparison with analytical solution obtained by the analytical method, the theoretical model uses the theoretically observed TEM response data obtained by the forward modeling method provided by the present disclosure; as shown in FIG. 3(a)˜ FIG. 3(d), the relative error between the 3D TEM forward modeling and the analytical solution is very small, and the relative error of the data in most time channels is less than 2%. The research results verify that the adaptive stepping method is able to greatly improve the forward calculation efficiency on the basis of ensuring the accuracy, capable of satisfying the needs of actual TEM data interpretation, and provide a good foundation for TEM three-dimensional inversion.

### Example 2

According to the ground transient electrical observation device in FIG. 4(a) and FIG. 5, the theoretical model shown in FIG. 6(a) is established. The theoretical model is mainly composed of upper and lower layers, so as to simulate the overall geological conditions of the overburden and bedrock in the survey region, the electrical conductivity is 0.01S/m and 0.002S/m, respectively. A high-resistance anomaly and a low-resistance horizontal plate are set up in the first layer, and the resistivity distribution of the anomaly is 0.001S/m and 0.2S/m; the theoretical model adopts the emission waveform shown in FIG. 4(b), and the current turn-off time is 2.58×10-4 s.

The inversion domain shown in FIG. 6(b) is established according to the ground transient electrical observation device in FIG. 4(a) and FIG. 5, and the inversion domain is discretized by using unstructured tetrahedral grids. The inversion region is −500m˜2500m in the X direction and −240m˜1660m in the Y direction, the distance from the terrain surface to Z=250m (the highest elevation of the terrain is 1468m). The size of the entire model region is 10km×10km×0 km, the X direction is between −4000m and 6000m, the Y direction is between −4500m and 5500m, and the Z direction is between −4000m and 6000m. The grid of the entire model contains 715,636 elements and 837,234 edges, and the inversion domain has 417,020 elements. As shown in FIG. 6(b), the initial model in the inversion of the theoretical model in FIG. 6(a) is a uniform space with a conductivity of 0.01S/m.

Through S4˜S9, after 25 inversion iterations of the theoretical model results in FIG. 6(a), the 3D view of the inversion results is shown in FIG. 6(c). It can be seen from the figure that 3D inversion recovers both anomalous bodies and bilayer structures. The inversion results of the theoretical model verify that the present disclosure is able to accurately interpret TEM data in complex terrain regions.

The inversion convergence curve is shown in FIG. 7. It can be seen from the figure that after 25 Gauss-Newton iterations, the normalized fitting converges to less than 2%. When using 2 MPI processes and 20 OpenMP threads in one cluster node, the computing time is about 67 hours.

For each Gauss-Newton iteration of the model, 10 LSQR iterations are used to update the model.

The relative error between the predicted data and the observed data is shown in FIG. 8, and the relative error of all measurement points is less than 5%.

The data fitting of the TEM sounding curves of some measurement points is shown in FIG. 9(a) to FIG. 9(c). It can be seen from the figure that the data fitting of the TEM sounding curves of the measurement points is good.

To sum up, compared with the related art, the present disclosure has the following advantageous effects:
The disclosure provides a parallel inversion method for ground TEM method. When acquiring the observed TEM response data, the curls on both sides of the quasi-static Maxwell equation system in the time domain is taken, and the first-order vector finite element method based on the unstructured tetrahedral grid is adopted to obtain the finite element analysis equation; Dirichlet boundary conditions are adopted to assume that the electric field vanishes on the boundary of the modeling region, and the initial condition of the electric field is set to zero, and the modeling region of the theoretical model is expanded. The grid is refined in the preset region of the measurement point and the emission source, and the size of the grid is gradually increased in other regions, and the setting of boundary conditions and initial conditions as well as the setting of the grid are completed. In this manner, the TEM response of complex geological structures may be accurately simulated.

The disclosure adopts the adaptive time step technology in the forward modeling process, adopts the second-order backward Euler method to discretize the time in the finite element analysis equation, and adopts the adaptive time stepping method. After calculating the step size for a certain number of times with the time step Δtₙ0.1, it is attempted to increase the step size to kₙ times Δtₙ₋₁.

Moreover, through the Taylor series expansion, the electric field time derivative expression of the non-uniform step size at various moments is obtained, and the finite element analysis equation is deformed. The present disclosure also takes into consideration that the iterative method is limited by the condition number of the equation, non-convergence may occur. After the boundary conditions and initial conditions are determined in the present disclosure, the electric field Eₙ at a certain moment may be obtained by solving the deformed finite element analysis equation by an iterative method or a direct method. During the solution process, when the time step is the same, and the stiffness matrix remains unchanged, the results of the matrix decomposition of finite element coefficient matrix Aₙ may be reused. Since the matrix decomposition of Aₙ for each Δtₙ has been stored, it is only necessary to perform the back-substitution solution phase of the direct solver. During the inversion process, when the present disclosure uses the implicit method of backward time stepping to solve the matrix-vector multiplication between the sensitivity matrix and the vector, the matrix decomposition result of Aₙ is reused in the inversion process, and MPI and OpenMP are combined for parallel computing. To sum up, the present disclosure considerably improves the efficiency of the forward and inversion modeling methods.

Combined with the sensitivity of the observed TEM response data to the model parameters, the present disclosure uses the Gauss-Newton method with a quasi-quadratic convergence rate to convert the objective function into a least squares problem. The disclosure has a quasi-quadratic convergence rate, obtains the model update direction, and uses line search to obtain the optimal model update step length, so the disclosure has good stability.

The disclosure calculates the product of the sensitivity matrix and the vector of the observed TEM response data to the model parameters by using the adjoint forward method. This approach greatly reduces the large amount of computation and memory requirements required to directly compute the sensitivity matrix. Therefore, the inversion scheme formed by the present disclosure is able to efficiently solve the three-dimensional TEM inversion problem under complex geological conditions.

Those skilled in the art can easily understand that the above are only preferred embodiments of the present disclosure, and are not intended to limit the present disclosure. Any modifications, equivalent replacements and improvements made within the spirit and principles of the present disclosure, etc. should all be included within the scope to be protected by the present 128343usf disclosure.

1. A parallel inversion method for a ground-based transient electromagnetic (TEM) method, comprising the following steps:
S1: acquiring an observed TEM response data for inversion, comprising collecting the observed TEM response data on the ground and using a theoretical model to obtain the observed TEM response data through a three-dimensional (3D) TEM forward modeling; wherein the theoretical model is a simulation model, which is obtaining the observed TEM response data;
S2: dividing an inversion domain into unstructured tetrahedral grids; wherein the inversion domain is an underground space corresponding to a measurement point;
S3: setting a conductivity value in the unstructured tetrahedral grids, constructing an initial inversion model, and combining the observed TEM response data to construct a regularized objective function of the initial inversion model;
S4: deriving model parameters in the initial inversion model in an edge electric field equation, and adopting an implicit method of backward time stepping to gradually calculate a sensitivity transposition of an electric field relative to the model parameters along all element edges, and then combining an interpolation matrix to calculate a product of a sensitivity matrix and a vector of the observed TEM response data to the model parameters;
S5: combining the sensitivity matrix and the vector of the observed TEM response data to the model parameters, converting an objective function into a least squares problem by using a Gauss-Newton method with a quasi-quadratic convergence rate, obtaining a model update direction, and using a line search to obtain an optimal model update step length;
S6: calculating the model parameters in combination with the model update direction and the optimal model update step length, and updating an inversion model; wherein a least squares algorithm is adopted to obtain the model update direction;
S7: performing the 3D TEM forward modeling on the inversion model, which is updated, based on a vector finite element method, and obtaining a predicted TEM response data;
S8: using a normalized error to evaluate a fit between the predicted TEM response data and the observed TEM response data; if the normalized error reaches a preset threshold, an inversion method is terminated; if the normalized error does not reach the preset threshold, and a number of current iterations is less than a set number of times, go to the step S4;
wherein the method for obtaining the theeretieally observed TEM response data comprises the following steps:
taking curl of both sides of a quasi-static Maxwell equation in a time domain, and using a first-order vector finite element method based on the unstructured tetrahedral grids to obtain a finite element analysis equation; wherein an element edge is used to discretize a TEM emission source, so that a wire or a coil is coincident with the edge of the grids;
discretizing a time in the finite element analysis equation by a second-order backward Euler method, and obtaining an electric field time derivative expression of a non-uniform step size at various moments through a Taylor series expansion, and deforming the finite element analysis equation;
using Dirichlet boundary conditions to assume that the electric field vanishes on a boundary of a modeling region, setting an initial condition of the electric field to zero, and expanding the modeling region of the theoretical model, and refining the grid in a preset region of the measurement point and the emission source, and gradually increasing the size of the grid in other regions, completing a setting of the boundary conditions and the initial conditions, as well as a setting of the grid;
based on the setting of the boundary conditions and the initial conditions and the setting of the grid, using a direct solver to solve the finite element analysis equation after the deformation, and calculating the electric field at the various moments;
calculating the observed TEM response data based on the electric field and a sparse interpolation matrix,
wherein a model parameter of a k-th inversion model is:
mₖ=mₖ₋₁+lδmₖ
wherein, mₖ is the model parameter of the k-th inversion model; mₖ₋1 is a model parameter of a k-1-th inversion model: δmₖ is the model update direction; l is the optimal model update step length.

2. (canceled)

3. The parallel inversion method for the ground-based TEM method according to claim 1, wherein the regularized objective function is:
$$φ ( m ) = {φ}_{d} ( m ) + {λφ}_{m} ( m )$$
$${φ}_{d} ( m ) = 0.5 {‖ {W}_{d} ( F ( m ) - {d}_{o b s} ) ‖}_{L 2}^{2}$$
$${φ}_{m} ( m ) = 0.5 {‖ {W}_{m} ( m - {m}_{ref} ) ‖}_{L 2}^{2}$$
$$λ = \frac{{‖ {J}^{T} {W}_{d}^{T} {W}_{d} ( Jx ) ‖}_{L 2}}{{‖ {W}_{m}^{T} ( {W}_{m} x ) ‖}_{L 2}}$$
wherein, φ_{d} is a data fitting term; φₘ is a model stabilizer term; λ is a regularization parameter; m is an inversion model parameter; m=log(σ); σ is a conductivity; W_{d}=diag (1/(d_{obs}+ε)); F(m) represents a forward response of an initial inversion model parameter m, d_{obs} is the observed TEM response data at the measurement point, Wₘ is a model roughness matrix, m_{ref} is a reference model parameter with prior information; x is random vector; J is the sensitivity of the observed TEM response data to the model parameters; L2 is a 2-norm; ε is an average of a observed data of a last time channel of the actual observed TEM response data.

4. The parallel inversion method for the ground-based TEM method according to claim 3, wherein the sensitivity of the electric field along the all element edges relative to the model parameters is:
Sₙ=∂En/∂m;
wherein, Sₙ is the sensitivity of the electric field along the all element edges relative to the model parameters at an n-th time step; a size of Sₙ is N_{ed}×Nₘ, N_{ed} is the number of grid edges; Nₘ is the number of the model parameters; En is an electric field at time tₙ;
Jₙ=QSₙ;
wherein, Q is the sparse interpolation matrix with a size N_{d}×N_{ed}; Jₙ is the sensitivity of the observed TEM response data at the n-th time step to the model parameters; N_{d} is the number of the data; the number of the data is a product of the number of time channels corresponding to an instrument used to measure the measurement point data and the number of the measurement points.

5. (canceled)

6. A parallel inversion system for a ground TEM method, comprising:
an acquisition circuit of a TEM data, which is configured to obtain an observed TEM response data for inversion, comprising a field data acquisition circuit and a three-dimensional TEM forward modeling unit circuit for theoretical model; wherein the three-dimensional TEM forward modeling circuit is a simulation model, which is obtaining the observed TEM response data;
a domain discretization circuit, which is configured to divide an inversion domain into unstructured tetrahedral grids; wherein the inversion domain is an underground space corresponding to a measurement point;
a constructing circuit of an initial inversion model, which is configured to set a conductivity value in the unstructured tetrahedral grids, construct the initial inversion model, and combine the observed TEM response data to construct an objective function of the initial inversion model;
a sensitivity calculating circuit, which is configured to calculate a sensitivity of the observed TEM response data to model parameters, wherein an implicit method of backward time stepping is adopted to gradually calculate a sensitivity transpose of an electric field along all element edges relative to the model parameters, then combine an interpolation matrix to calculate a product of a sensitivity matrix and a vector of the observed TEM response data to the model parameters;
an acquisition circuit of model update parameters, which is configured to combine the sensitivity of the observed TEM response data to the model parameters, use a Gauss-Newton method with a quasi-quadratic convergence rate to convert an objective function into a least-square problem, obtain a model update direction, and use a line search to obtain an optimal model update step length;
a model update circuit, which is configured to calculate the model parameters by combining the model update direction and the optimal model update step length, and update an inversion model; wherein a least squares algorithm is adopted to obtain the model update direction;
an acquisition circuit of a predicted TEM response data, which is configured to perform a 3D TEM forward modeling of the inversion model based on a vector finite element method, and obtain the predicted TEM response data;
an error evaluation circuit, which is configured to evaluate a fitting between the predicted TEM response data and the observed TEM response data by using a normalized error; if the data misfit reaches a preset threshold, an inversion method is terminated; if the data misfit does not reach the preset threshold, and a number of current iterations is less than a set number of times, then drive the sensitivity calculation circuit of the observed TEM response data to the model parameters to perform an operation;
wherein the 3D TEM forward modeling circuit for theoretical model comprises:
a finite element analysis equation circuit, which is configured to take curl operator on both sides of a quasi-static Maxwell equation in a time domain, and use a first-order vector finite element method based on the unstructured tetrahedral grids to obtain a finite element analysis equation; wherein an edge of a grid circuit is adopted to discretize a TEM emission source, so that a wire or a coil is coincident with an element edge;
a finite element analysis equation circuit, which is configured to discretize a time in the finite element analysis equation by using a second-order backward Euler method, and obtain an electric field time derivative expression of a non-uniform step size at various moments through a Taylor series expansion, and deform the finite element analysis equation;
a condition setter, which is configured to use Dirichlet boundary conditions to assume that the electric field vanishes on a boundary of a modeling region, setting an initial condition of the electric field to zero, and expanding the modeling region of the theoretical model, and refining the grid in a preset region of the measurement point and the emission source, and gradually increase the size of the grid in other regions, complete a setting of the boundary conditions and the initial conditions, as well as a setting of the grid;
an electric field circuit, which is configured to solve the finite element analysis equation after the deformation with a direct solver based on the setting of the boundary conditions and the initial conditions and the setting of the grid, and calculate the electric field at the various moments;
a circuit of the observed TEM response data, which is configured to calculate the observed TEM response data according to the electric field and a sparse interpolation matrix;
wherein a model parameter of a k-th inversion model is:
mₖ=mₖ₋₁+lδmₖ
wherein, mₖ is the model parameter of the k-th inversion model; mₖ₋₁ is a model parameter of a k-1-th inversion model; δmₖ is the model update direction; l is the optimal model update step length.

7. (canceled)

8. The parallel inversion system for the ground TEM method according to claim 6, wherein the regularized objective function is:
$$φ ( m ) = {φ}_{d} ( m ) + {λφ}_{m} ( m )$$
$${φ}_{d} ( m ) = 0.5 {‖ {W}_{d} ( F ( m ) - {d}_{o b s} ) ‖}_{L 2}^{2}$$
$${φ}_{m} ( m ) = 0.5 {‖ {W}_{m} ( m - {m}_{ref} ) ‖}_{L 2}^{2}$$
$$λ = \frac{{‖ {J}^{T} {W}_{d}^{T} {W}_{d} ( Jx ) ‖}_{L 2}}{{‖ {W}_{m}^{T} ( {W}_{m} x ) ‖}_{L 2}}$$
wherein, φ_{d} is a data fitting term; φₘ is a model stabilizer term; λ is a regularization parameter; m is an inversion model parameter; m=log(σ); σ is a conductivity; W_{d}=diag (1/(d_{obs}+ε)); F(m) represents a forward response of an initial inversion model parameter m, d_{obs} is the observed TEM response data at the measurement point, Wₘ is a model roughness matrix, m_{ref} is a reference model parameter with a prior information; x is a random vector; J is the sensitivity of the observed TEM response data to the model parameters; L2 is a 2-norm; ε is is an average of a observed data of a last time channel of the actual observed TEM response data.

9. The parallel inversion system for the ground TEM method according to claim 8, wherein the sensitivity of the electric field along the all element edges relative to the model parameters is:
Sₙ=∂En/∂m;
wherein, Sₙ is the sensitivity of the electric field along the all element edges relative to the model parameters at an n-th time step; a size of Sₙ is N_{ed}×Nₘ, where N_{ed} is the number of grid edges; Nₘ is the number of the model parameters; En is the electric field at time tₙ;
Jₙ=QSₙ;
wherein, Ω is the sparse interpolation matrix with a size N_{d}×N_{ed}; Jₙ is the sensitivity of the observed TEM response data at the n-th time step to the model parameters; N_{d} is the number of the data; the number of the data is a product of the number of time channels corresponding to an instrument used to measure the measurement point data and the number of the measurement points.

10. (canceled)
